(19) United States
(12) Patent Application Publication
(10) Pub. No.: US 2017/0046671 A1
(43) Pub. Date: Feb. 16, 2017

(54) ONLINE MOBILE PAYMENT SYSTEM AND METHOD USING A QR CODE

(71) Applicants: Jack Shauh, San Diego, CA (US); Kuo-Chun Lee, San Diego, CA (US); Andrew Vinh Banh, Irvine, CA (US)

(72) Inventors: Jack Shauh, San Diego, CA (US); Kuo-Chun Lee, San Diego, CA (US); Andrew Vinh Banh, Irvine, CA (US)

(21) Appl. No.: 15/233,004

(22) Filed: Aug. 10, 2016

Related U.S. Application Data
(60) Provisional application No. 62/202,911, filed on Aug. 10, 2015.

(51) Int. Cl. G06Q 20/10; G06Q 20/32; G06K 7/10; G06Q 30/06; G06K 19/06; G06K 7/14

(52) U.S. Cl. CPC G06Q 20/102; G06K 19/06037; G06K 7/1417; G06K 7/10722; G06K 19/06112; G06Q 30/0601; G06Q 20/322

(57) ABSTRACT

A mobile payment system including a web browsing capable device is in communication with a world wide web to make purchases online at a web page of an online merchant. A QR code is associated with a purchase from the online merchant and displayed on the web browsing capable device. A mobile payment device including securely stored payment information and having a camera is connectable to the online merchant to provide payment for the online purchase using information retrieved from the QR code displayed by the web browsing capable device and obtained by the camera. The online store is connectable to a payment network to exchange payment messages upon receiving payment information from the mobile device.

### CROSS-REFERENCE TO RELATED APPLICATION

This application claims the benefit of U.S. Provisional Application No. 62/202,911, filed 10 Aug. 2015.

### FIELD OF THE INVENTION

This invention relates to mobile payment systems.

More particularly, the present invention relates to mobile payment for online purchases.

### BACKGROUND OF THE INVENTION

In the payments industry, mobile payments systems are becoming more widely used. Mobile payment applications as a virtual credit/debit card are starting to be provided to mobile devices such as smart phones, tablets, watches and other wearable devices, and the like. Mobile payment methods currently include Apple Pay, Android Pay, etc. As an example, a mobile device capable of mobile payment can be used in a point of sale (POS) terminal to pay for a sale in a retailer store. Mobile payment can provide strong security to prevent fraud by implementing EMV (Europay, MasterCard and Visa) Integrated Circuit Card Specifications for Payment Systems. Furthermore, mobile payment can provide strong security by implementing EMV Payment Tokenization Specifications, or vendor specific payment token scheme. In addition, the biometric verification may be provided by the mobile device to authenticate the owner of the mobile device, similar to the card holder verification.

However, the existing mobile payment cannot be used in online purchasing when the purchaser is purchasing through a PC or other web browsing capable device and the mobile payment resides on a different mobile device. In this case, the purchaser has to manually enter credit or debit card number on the web page of the online store, which can create security fraud because there is no strong authentication in the purchase process.

It would be highly advantageous, therefore, to remedy the foregoing and other deficiencies inherent in the prior art.

An object of the present invention is to provide a method and system of mobile payment for use with a PC.

Another object of the present invention is to provide a secure method and system of mobile payment for use with a PC.

### SUMMARY OF THE INVENTION

Briefly, to achieve the desired objects and advantages of the instant invention, provided is a mobile payment system including a web browsing capable device in communication with a world wide web to make purchases online at a web page of an online merchant. A QR code is associated with a purchase from the online merchant and displayed on the web browsing capable device. The QR code includes identifying information for the purchase, contact information for the online store, and payment information. A mobile payment device includes a camera and has securely stored payment information, such as card information, credential, and the like. The mobile payment device is connectable to the online merchant to provide payment for the online purchase from the web browsing capable device with information retrieved from the QR code displayed by the web browsing capable device and obtained by the camera. The online store is connectable to a payment network to exchange payment messages upon receiving payment information from the mobile device.

A merchant module is included with the web page of the online store, the merchant module including a QR code generator to generate the QR code associated with the online purchase. A mobile device module is included with the mobile device. The mobile device module includes a QR code reader to decipher the information carried by the QR code and a mobile payment interface, coupling module functions with a mobile payment core within the mobile device.

Also provided is a mobile payment method including the steps of providing a web browsing capable device, and providing a mobile payment device including a camera and having mobile payment capability. The web browsing capable device is used in communication with the Internet to make an online purchase at a web page of an online merchant. A QR code is associated with the online purchase and displayed on the web browsing capable device. The QR code is obtained from the web browsing capable device with the mobile device using the camera. The mobile device is connected to the online merchant using information obtained from the QR code, and payment information is sent to the online merchant.

In another aspect, the step of associating a QR code with the online purchase includes providing a merchant module with the web page of the online merchant. The merchant module includes a QR code generator to generate the QR code associated with the online purchases, and display the QR code on the web browsing capable device.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is simplified block diagram of the payment system according to the present invention;

FIG. 2 is a schematic of the message exchange between elements of the payment system with a purchaser, according to the present invention;

FIG. 3 is a schematic of the message exchange between elements of the payment system including a payment server, with a purchaser, according to the present invention;

FIG. 4 is a schematic of another message exchange between elements of the payment system including a payment server, with a purchaser, according to the present invention;

FIG. 5 is a functional diagram of the payment elements of the mobile payment device; and

FIG. 6 is a functional diagram of the plug-in software module for the online merchant.

### DETAILED DESCRIPTION OF THE PREFERRED EMBODIMENTS

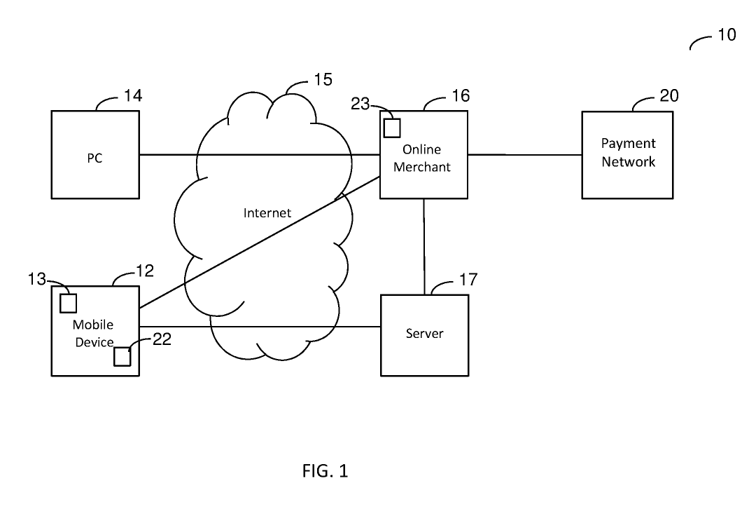

Turning now to the drawings in which like reference characters indicate corresponding elements throughout the several views, attention is first directed to FIG. 1 which illustrates a payment system 10 including a mobile payment device 12 and a PC 14 (web browsing capable device). Mobile payment device 12 is a device with computing capability and is embedded with a secure element or utilizes emulation software to emulate a secure element to securely store credit/debit card information, payment credentials, one-time credit/debit card number, payment token, etc. Mobile payment device 12 also includes a camera 13, and can be a smart phone, a tablet, a wearable device (e.g. watch), or even a laptop PC, embedded with a secure element or utilizing emulation software to emulate a secure element, that stores credit/debit card, payment credentials, one-time credit/debit card number, payment token, etc. Currently mobile payment platforms include Apple Pay, Android Pay and the like. PC 14 can be any browser capable device such as a desktop PC, a laptop PC, a tablet PC, mobile phone (or smart phone), etc. to browse products of the online store. In this case, PC 14 is either incapable of mobile payment, or mobile payment is undesirable from that specific device. System 10 enables a secondary device, in this case mobile payment device 12 to pay for online purchases at an online merchant 16 made from PC 14. It will be understood that the term online refers to communication through a world wide web such as the Internet 15, a global communications network. Many purchasers prefer to browse on a larger device such as a desk top computer because a larger viewing area is provided. Unfortunately, mobile payment is not available on many of these systems. System 10 allows browsing on a PC 14 while facilitating payment with a mobile payment device 12.

Online merchant 16 is coupled to mobile device 12, either directly through internet 15, or through a server 17. Payment through an intermediate server 17 is fully disclosed in application Ser. No. 15/203,779, entitled, “ONLINE MOBILE PAYMENT USING A SERVER” filed on Jul. 6, 2016 and included herein by reference. Thus, mobile device 12 directly connects to online merchant 16 via internet 15 with 3G, 4G, WiFi access, or the like for payment message exchange, connects to online merchant 16 via payment server 17 via internet 15 with 3G, 4G, WiFi access or the like for payment message exchange or connects to payment server 17 while PC 14 also connects to payment server 17 via internet 15. In this last arrangement, payment server 17 can relay payment messages to PC 14 which forwards the messages to online merchant 16. Payment server 17 functions as a hub between a plurality of mobile devices 12 and online merchants 16.

As an example of general use, PC 14 connects to online merchant 16 via internet connection 15. Online merchant 16 connects to a payment network 20 to process the credit, debit or bank card transaction approval. Payment network may comprise payment gateway, acquiring bank, card issuing bank, etc. Mobile device 12 is capable of mobile payment and is reachable by online merchant 16 directly or through server 17 using internet link 15 to exchange mobile payment messages. Mobile device 12 can use 2G, 3G, or 4G cellular networks, or home, private or public Wi-Fi as the access technology of internet 15. To provide the required functionality, both mobile payment device 12 and online merchant 16 require 3rd party software modules 22 and 23 respectively (FIG. 1), installed to enable system 10. This enables a QR code to be generated by online merchant. The QR code is associated with the online purchase with identifying information for the purchase such as a transaction ID or the like. QR code contains information needed to connect mobile device 12 and merchant 16, either directly or through payment server 17, including identifying information for the transaction, payment information, and contact information such as the URL address of online merchant 16 and merchant ID. Mobile device 12 obtains the QR code for the purchase using camera 13 to begin the payment processing.

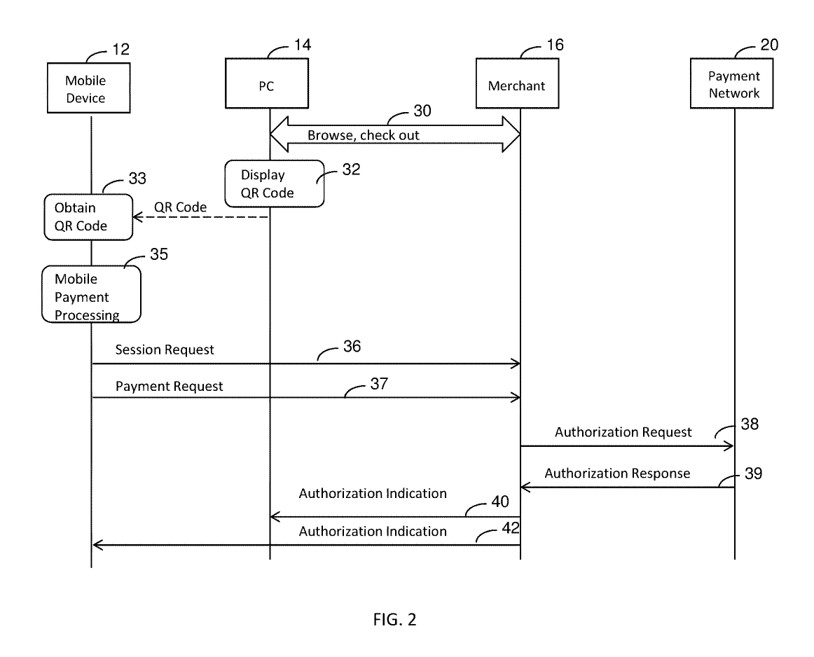

Referring now to FIG. 2, an example of the message flow for a mobile payment using system 10 is illustrated. The purchaser browses the web page of online merchant 16, selects product(s) and decides to check out 30 using a QR code option. The web page of online merchant 16 includes module 23 that can display 32 a QR code on PC 14. As will be described, module 23 generates a QR code associated with a purchase to identify a particular transaction. The QR code is generated to include all the information necessary for the transaction. The QR code includes information such as payment amount, currency code, transaction time, merchant name, merchant Id, transaction Id, purchase description, URL address of online merchant 16, etc. The purchaser launches a mobile payment option of mobile device 12 using module 22 to activate camera 13 to obtain 33 an image of the QR code displayed on PC 14 and extract the information in the QR code, such as payment amount, currency code, transaction time, merchant name, merchant Id, transaction Id, purchase description, URL address of merchant, etc. Module 22 can display payment information such as payment amount, merchant name, purchase description, etc. to the purchaser on mobile device 12. Module 22 continues to interact with a mobile payment core to process mobile payment 35 as will be described presently. As a result, the mobile payment core generates some application cryptogram, such as that of EMV, etc. to prove the authenticity of credit card, debit card or bank card. The mobile payment core can generate a payment token to replace the real credit card, debit card or bank card number. The mobile payment core can also require biometric verification of the purchaser, such as to verify the finger print of the purchaser, etc. Mobile device 12 uses the URL address of online merchant 16, obtained from the QR code, to set up a session 36 with online merchant 16. To provide security, a secure link such as HTTPS may be set up between mobile device 12 and online merchant 16. For example, the secure link can be achieved by a shared security key between online merchant 16 and mobile device 12, or by a security certificate of online merchant 16 and the like. Mobile device 12 sends a payment request 37 to online merchant 16 to pay for the product purchased. Payment request 37 includes payment information, such as payment amount, currency code, transaction time, merchant Id, transaction Id, cryptogram, mobile payment token, etc. Online merchant 16 receives payment request 37 and can associate the request with a specific purchase from the purchase identifying information (I.e. transaction ID) and sends an authorization request 38 to payment network 20 to request approval of the transaction. With the transaction Id, online merchant 16 can identify the correct PC or web page the transaction is associated with and online merchant is able to send an authorization indication in a later step. Payment network 20 replies to online merchant 16 with an authorization response 39 if and when the transaction is approved. Online merchant 16 sends an authorization indication 40 to PC 14 by displaying a message on the web page that the transaction is completed. Online merchant 16 can also send an authorization indication 42 to mobile device 12.

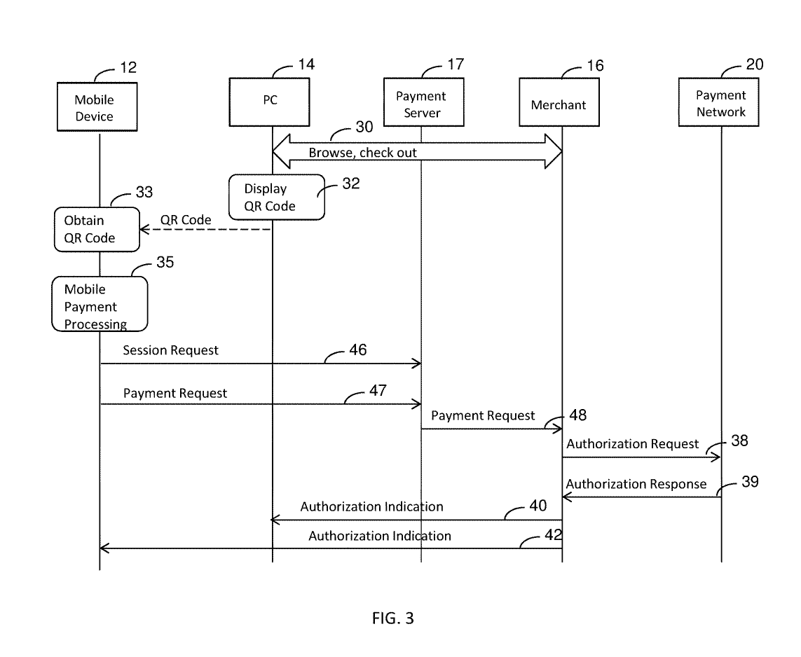

Turning now to FIG. 3, another example of a message flow is illustrated. In this example, payment server 17 provides a central hub to connect a plurality of mobile devices 12 and online merchants 16 for mobile payment. As in the previous message flow of FIG. 2, the message flow in FIG. 3 begins with the purchaser browsing the web page of online merchant 16, selecting product(s) and checking out 30 using a QR code option. The web page of online merchant 16 again has plug-in module 23 that will display a QR code on PC 14. The QR code includes information, such as payment amount, currency code, transaction time, merchant name, merchant Id, transaction Id, purchase description, URL address of payment server 20, etc. The purchaser launches a mobile payment application on mobile device 12 which has a module 22. The module activates camera 13 to obtain 33 an image of the QR code displayed on PC 14 and extract the information in the QR code, such as payment amount, currency code, transaction time, merchant name, merchant Id, transaction Id, purchase description, URL address of payment server 20, etc. Module 22 displays payment information, such as payment amount, merchant name, purchase description, and the like, to the purchaser on mobile device 12. Module 22 using a mobile payment core begins processing the mobile payment 35 as described previously. In this example, however, mobile device 12 then uses the URL address of payment server 17 to request a payment session and 46 to set up a payment session with payment server 17. To provide security, a security link, such as HTTPS, may be set up between mobile device 12 and payment server 17. For example, security can be achieved by a common security key between payment server 17 and mobile device 12, or by a security certificate of payment server 17 and the like. Mobile device 12 then sends a payment request 47 to payment server 17 to pay for the product purchased. Payment request 47 can include payment information, such as payment amount, currency code, transaction date and time, merchant Id, transaction Id, cryptogram, mobile payment token, etc. Payment server 17 uses the online merchant Id contained in the payment information to identify the correct online merchant 16 and then forwards the payment request 48 to online merchant 16. The remaining steps in the process are identical to those described in conjunction with FIG. 2. Alternatively, an authorization indication message can be sent from online merchant 16 to payment server 17 which propagates an authorization indication to PC 14. Also, an authorization indication message can be sent from online merchant 16 to payment server 17 which propagates an authorization indication to mobile device 12.

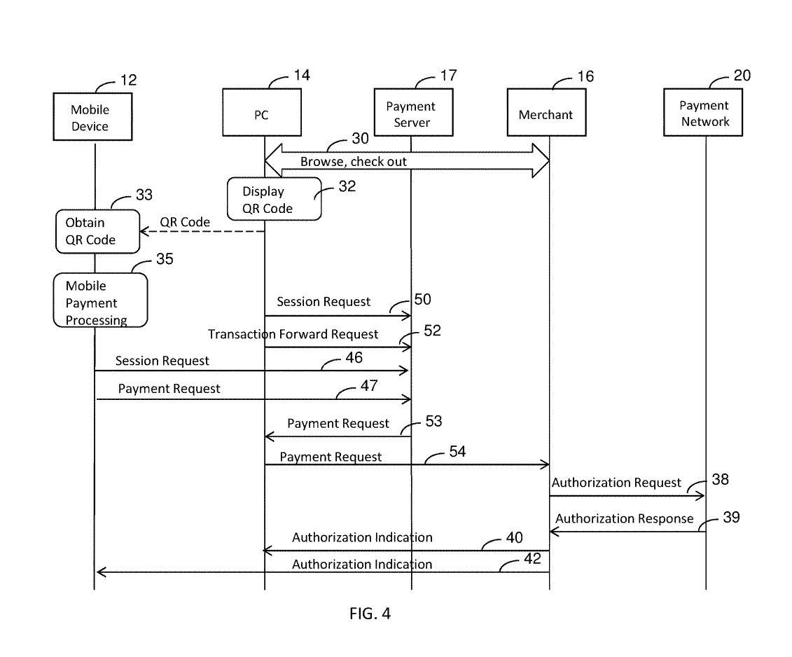

Turning now to FIG. 4, another example of a message flow is illustrated. In this example, payment server 17 again provides a central hub to connect a plurality of mobile devices 12 and online merchants 16 for mobile payment. In this example, as in the example of FIG. 3, a payment server 17 functions as a relay node whereby mobile device 12 can send messages to PC 14 which can then forward the payment messages to online merchant 16. This example includes the purchaser browsing the web page of online merchant 16, selecting product(s) and checking out 30 using a QR code option with a QR code displayed on PC 14, and the mobile device 12 obtaining 33 an image of the QR code displayed on PC 14 as with the example of FIG. 3. Module uses the mobile payment core of mobile device 12 to begin processing the mobile payment 35 as described previously. PC 14 uses the URL address of payment server to set up a session 50 with payment server 17. To provide security, a secure link such as HTTPS may be set up between PC 14 and payment server 17. For example, this may be achieved by a shared security key between payment server and online merchant 16 which may generate a HTTPS session key for PC 17. Subsequent messages from PC 14 may include message authentication code that may be generated by transaction information, such as payment amount, transaction time, time information (e.g. for the message generation), merchant Id, etc., and security key. PC 14 sends a Transaction Forward Request 52 to payment server 17. Transaction Forward Request 52 includes information such as the merchant Id and transaction Id which permits payment server 17 to associate the transaction with the appropriate mobile device 12. Mobile device 12 then uses the URL address of payment server 17 to request a payment session 46 and to set up a payment session with payment server 17. To provide security, a security link, such as HTTPS, may be set up between mobile device 12 and payment server 17. For example, security can be achieved by a common security key between payment server 17 and mobile device 12, or by a security certificate of payment server and the like. Mobile device 12 then sends a payment request 47 to payment server 17 to pay for the product purchased. Payment request 47 can include payment information, such as payment amount, currency code, transaction time, merchant Id, transaction Id, cryptogram, mobile payment token, etc. Payment server 17 receives payment request 47 from mobile device 12 and uses the merchant Id and transaction Id information to match with the same merchant Id and transaction Id information received from PC 14 in transaction forward request 52. Payment server 17 is then able to forward a payment request 53 to the correct PC 14 for the correct transaction. PC 14 receives payment request 54 from payment server 17 and forwards payment request 54 to online merchant 16. The remaining authorization steps are the same as previously described.

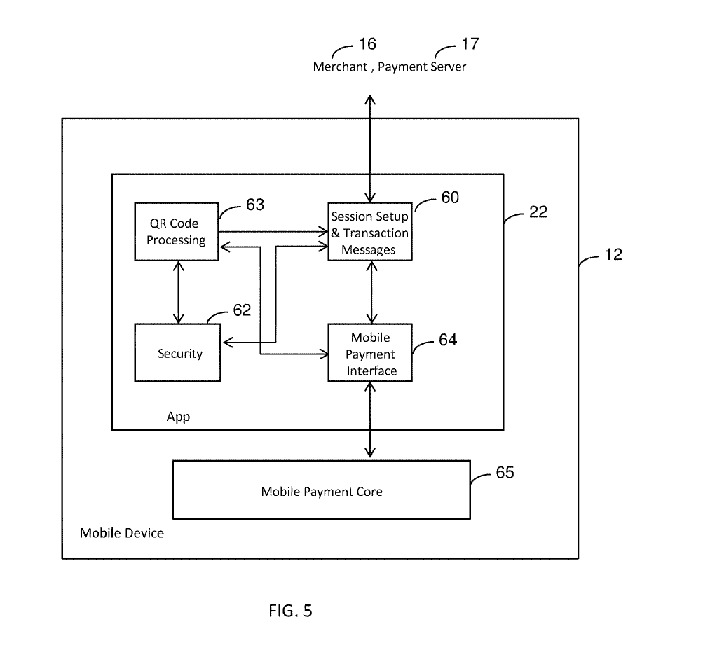

Turning now to FIG. 5, module 22 of mobile device 12 is illustrated. Session setup and transaction 60 provides the functionality of session setup with online merchant 16 or payment server 17 as well as transmits and receives messages, such as session request 36, 46, payment request 37, 47, etc. Session setup and transaction 60 generates messages included the necessary information obtained from the QR code, so that a payment session can be set up for the correct online merchant 16, the correct payment server 17, and the correct purchase. Security 62 supports a secured link for the session with online merchant 16 and payment server 17. QR code processing 63 obtains the image of the QR code and includes a QR code reader to retrieve information carried by the QR code. The information retrieved is used to display to the purchaser payment details, to set up sessions and to interface with the mobile payment core 65. Mobile payment interface 64 interfaces with mobile payment core 65 to request payment information and receive response during processing. Mobile payment core 65 exists in mobile device 12 outside module 22 for digital wallet purpose, such as Apple Pay, Android Pay, EMV, etc. It can include credentials of credit/debit/bank card and can receive API requests from mobile payment interface 64 and reply with some cryptogram, payment token or payment message.

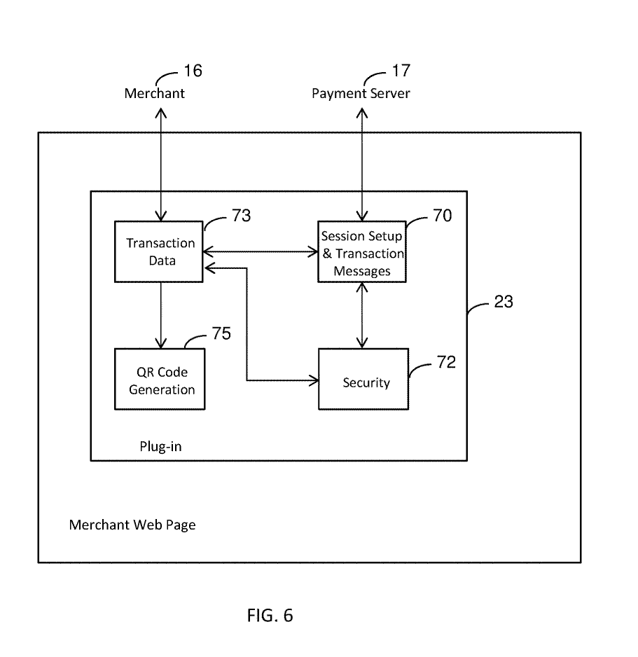

Referring to FIG. 6, the web page of online merchant includes module 23 as illustrated. The web page of online merchant 16 not only supports the purchaser to browse products, select products and check out, it also includes a module 23 for the additional functions, such as QR code generation, setting up a session with payment server 17, etc. Module 23 includes session setup and transaction 70 to provide messages necessary to set-up a session with payment server 17 and receive payment request message 48 from payment server 17. Security 72 provides a secured link for the session with payment server 17. For example, the secured link can be achieved by a shared security key between payment server 17 and online merchant 16. Security 72 can also generate a message authentication code. Some operations may need input data from transaction data. Transaction data 73 stores purchase data which comes from online merchant 16. Data may include payment amount, currency code, transaction time, merchant name, merchant Id, transaction Id, purchase description, or URL address of online merchant 16, URL address of payment server 17, etc. for the transaction processing until the end of the payment transaction. QR Code Generation 75 provides the generation of a QR code. Information included in the QR code may come from the transaction data 73.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A mobile payment system comprising:
a web browsing capable device in communication with a world wide web to make purchases online at a web page of an online merchant;
a QR code associated with a purchase from the online merchant and displayed on the web browsing capable device, the QR code including identifying information for the purchase, contact information for the online store, and payment information;
a mobile payment device including a camera and having securely stored payment information, the mobile payment device connectable to the online merchant to provide payment for the online purchase from the web browsing capable device with information retrieved from the QR code displayed by the web browsing capable device and obtained by the camera; and
wherein the online store is connectable to a payment network to exchange payment messages upon receiving payment information from the mobile device.

2. A system as claimed in claim 1 further comprising a merchant module included with the web page of the online store, the merchant module including a QR code generator to generate the QR code associated with the online purchase.

3. A system as claimed in claim 2 further including a mobile device module included with the mobile device, the mobile device module including a QR code reader to decipher the information carried by the QR code.

4. A system as claimed in claim 3 wherein the mobile device module includes a mobile payment interface coupling module functions with a mobile payment core within the mobile device.

5. A system as claimed in claim 1 wherein the mobile device is connectable directly with the online merchant.

6. A system as claimed in claim 1 wherein the mobile device is connectable to the online merchant through a payment server.

7. A system as claimed in claim 1 wherein the mobile device is connectable to the online merchant through a payment server and a web browsing capable device.

8. A system as claimed in claim 1 wherein the identifying information for the purchase is a transaction ID.

9. A mobile payment method comprising the steps of:
providing a web browsing capable device;
providing a mobile payment device including a camera and having mobile payment capability;
using the web browsing capable device in communication with the Internet to make an online purchase at a web page of an online merchant;
associating a QR code with the online purchase;
displaying the QR code on the web browsing capable device;
obtaining the QR code from the web browsing capable device with the mobile device using the camera;
connecting the mobile device to the online merchant using information obtained from the QR code; and
sending payment information to the online merchant.

10. A method as claimed in claim 9 wherein the step of associating a QR code with the online purchase further comprises the steps of:
providing a merchant module included with the web page of the online merchant, the merchant module including a QR code generator to generate the QR code associated with the online purchases; and
the online merchant generating the QR code for the online purchase and displaying the QR code on the web browsing capable device.

11. A method as claimed in claim 9 wherein the step of connecting the mobile device to the online merchant includes providing online merchant contact information in the QR code.

12. A method as claimed in claim 9 wherein the step of obtaining the QR code from the web browsing capable device includes the step of providing a mobile device module with the mobile device, the mobile device module including a QR code reader to decipher the information carried by the QR code.

13. A method as claimed in claim 12 wherein the step of providing a mobile device module includes providing a mobile payment interface coupling module functions of the mobile device module with a mobile payment core within the mobile device.

14. A method as claimed in claim 9 wherein the step of connecting the mobile device to the online merchant includes connecting the mobile device directly with the online merchant.

15. A method as claimed in claim 9 wherein the step of connecting the mobile device to the online merchant includes connecting the mobile device to the online merchant through a payment server.

16. A method as claimed in claim 9 wherein the step of connecting the mobile device to the online merchant includes connecting the mobile device to the online merchant through a payment server and a web browsing capable device.

17. A method as claimed in claim 10 wherein the step of associating the QR code with the online purchase includes inserting identifying information for the purchase in the QR code during QR code generation.

18. A method as claimed in claim 17 wherein the step of inserting identifying information includes using a transaction ID.
